(19) United States
(12) Patent Application Publication
(10) Pub. No.: US 2020/0239017 A1
(43) Pub. Date: Jul. 30, 2020

(54) Collision Avoidance System for Off-Road Vehicles

(71) Applicant: ENASI Industries, Inc., Quebec (CA)

(72) Inventors: Denis Gagnon, Quebec (CA); Eric Dube, Quebec (CA)

(21) Appl. No.: 16/257,634

(22) Filed: Jan. 25, 2019

(51) Int. Cl. B60W 50/14; B60W 30/08; G08G 1/16

(52) U.S. Cl. CPC B60W 50/14; B60W 30/08; B60W 2050/146; G08G 1/166; B60Y 2200/20; G08G 1/165

(57) ABSTRACT

A collision avoidance system for at least one off-road vehicle operating in an environment, wherein the collision avoidance system includes a receiving unit for receiving signals transmitted by transmitting units associated with other vehicles and/or objects, a processor for processing signals received by the receiving unit; and a display for displaying color patterns or sequences that indicates the type(s) of the vehicle and/or objects detected, wherein the display of the color patterns or sequences indicates the type(s) of the vehicles or objects detected in the environment by the receiving unit of the off-road vehicle.

### BACKGROUND OF THE INVENTION

The present invention is generally directed to collision avoidance systems, and in particular, to a collision avoidance system for off-road vehicles operating in an environment.

Collision avoidance systems for off-road vehicles are known in the art. For example, U.S. Pat. No. 7,265,665 describes a method of proximity detection that includes detecting a received RF signal emitted by a target in range and providing an alarm signal to warn of the proximity of the target. Also described therein is the use of a “beacon” mode. Also known is Canadian application No. 2600903, which describes a collision alert module that can indicate the range of a group of oncoming vehicles and provides alerts to distinguish a single vehicle from a group of vehicles and for differentiating a “stranger” vehicle from a “stranger” group of vehicles.

However, additional improvements are desirable. For example and not limitation, it would be desirable to be able to distinguish between types of vehicles and/or objects detected in the environment, moving or otherwise, and convey such information, such as the type of vehicle detected in the environment, to the rider of the off-road vehicle(s) operating in the environment. It is thus believed that further advances to the state of the art are both desirable and achievable, all of which are provided by the embodiments disclosed herein.

### SUMMARY AND OBJECTIVES OF THE INVENTION

It is thus an objective of the present invention to overcome the perceived deficiencies in the prior art.

For example, objectives of the present invention include providing a display, which can be viewed by a rider of an off-road vehicle, that can, for example, provide immediate information to the rider, such as by way of example and not limitation, an indication that no other vehicles or objects, moving or otherwise, are within range, that another similar (or not similar) vehicle has been detected to be within range, that more than one of such vehicles has been detected within range, that a snow groomer or surfacing vehicle has been detected within range, that an emergency vehicle has been detected within range, that the rider is in a convoy with no other vehicles detected within range, and/or that the rider is approaching a danger point or other obstacle (or that said danger point or other obstacle has been detected within range). Although the present invention contemplates the ability to use tactile, audio, or other types of alert, the preferred means and method for alerting the rider to the aforementioned vehicles and/or other objects, moving or otherwise, is a color display, as more fully disclosed herein.

In a specific objective of the present invention, the collision avoidance system constructed in accordance with the present invention provides for use of a color coded display for displaying and/or indicating the type of the moving vehicle or object detected within range of the rider's off-road vehicle.

Further objects and advantages of this invention will become more apparent from a consideration of the drawings and ensuing description.

The invention accordingly comprises the features of construction, combination of elements, methods of operation and arrangement of parts which will be exemplified in the construction, illustration and description hereinafter set forth, and the scope of the invention will be indicated in the claims.

Therefore, to overcome the perceived deficiencies in the prior art and to achieve the objects and advantages set forth above and below, a preferred embodiment of the present invention is, generally speaking, directed to a collision avoidance system for at least one off-road vehicle operating in an environment, wherein the environment comprises at least one vehicle or object of a first type comprising a transmitting unit that transmits a signal that indicates the type of the at least one vehicle or object to which the transmitting unit is associated, and wherein the at least a first off-road vehicle is of a second type, and comprises the collision avoidance system that itself comprises: a receiving unit for receiving the signal transmitted by the transmitting unit associated with the at least one vehicle or object; a processor for processing signals received by the receiving unit; and a display for displaying a first color pattern or sequence that indicates the type of the at least one vehicle or object; wherein the display of the first color pattern or sequence indicates the type of the at least one vehicle or object detected in the environment by the receiving unit of the off-road vehicle.

In another preferred embodiment, the present invention is directed to a method of distinguishing at least a first vehicle or object of a first type from at least a vehicle of a second type in a collision avoidance system for at least one off-road vehicle operating in an environment, wherein the at least one vehicle or object of the first type comprises a transmitting unit that transmits a signal that indicates the type of the at least one vehicle or object, the at least second vehicle of the second type comprises a transmitting unit that transmits a signal that indicates the type of the at least second vehicle, the at least first off-road vehicle is of the second type and comprises (i) a receiving unit for receiving signals transmitted by the transmitting units associated with the at least first vehicle or object and the at least second vehicle, (ii) a processor for processing signals received by the receiving unit, and (iii) a display that displays a first color pattern or sequence indicative of the type of the at least one vehicle or object and displays a second color pattern or sequence indicative of the type of the at least second vehicle, wherein the method comprises the steps of detecting, by the receiving unit associated with the off-road vehicle, the signals being transmitted by the respective transmitting units associated with the at least first vehicle or object of the first type and the at least second vehicle of the second type; and displaying on the display the first color pattern or sequence to indicate the detection of the signal from the at least first vehicle or object of the first type and/or the second color pattern or sequence to indicate the detection of the signal from the at least second vehicle of the second type; wherein a rider associated with the at least first off-road vehicle can distinguish between the detection of a vehicle or object of the first type and the detection of a vehicle of the second type based on the one or more colors patterns or sequences being displayed on the display.

And in yet another preferred embodiment, the present invention is directed to a collision avoidance system for at least one off-road vehicle operating in an environment, wherein the environment comprises (i) a vehicle or object of a first type comprising a transmitting unit that transmits a signal that provides identifying information about the at least one vehicle or object to which the transmitting unit is associated and/or (ii) a vehicle of a second type comprising a transmitting unit that transmits a signal that provides identifying information about the at least second vehicle to which the transmitting unit is associated; and wherein the at least first off-road vehicle is of a second type, and comprises the collision avoidance system that itself comprises: a receiving unit for receiving the signals transmitted by the transmitting units associated with the at least first vehicle or object and the at least second vehicle; a processor for processing signals received by the receiving unit; and a display for displaying, simultaneously and/or individually, different color patterns or sequences that indicates one or more of the following:
a. an indication that the receiving unit is not receiving a signal from the at least first vehicle or object or the second vehicle;
b. an indication that the receiving unit is receiving a signal from the first vehicle or object and/or the second vehicle;
c. an indication that the receiving unit is receiving a signal from a vehicle or object of the first type;
d. an indication that the receiving unit is receiving a signal from a vehicle of the second type;
e. an indication that the receiving unit is receiving a signal from more than one vehicle or object of the first type;
f. an indication that the receiving unit is receiving a signal from more than one vehicle of the second type;
g. an indication that the signal being received from the vehicle or object of the first type is a snow groomer or surfacing vehicle or emergency vehicle;
h. an indication that the off road vehicle is in a convoy with no other vehicles of the second type; and/or
i. an indication that the off-road vehicle is approaching an object of the first type and the type of the object of the first type.

In a preferred embodiment, the off-road vehicle is a snowmobile, quad or other type of ATV.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 illustrates an exemplary environment in which preferred embodiments of the present invention can operate, along with illustrating vehicles and objects contemplated to be within the environment;

FIG. 2 illustrates a block diagram of a vehicle and/or object detection and display unit constructed in accordance with preferred embodiments of the present invention; and

FIG. 3 illustrates exemplary color patterns and sequences that indicate one or more of the information parameters, including but not limited to the vehicle type or object type, detectable by the off-road vehicle as disclosed herein.

Identical reference numerals in the figures are intended to indicate like parts, although not every feature in every figure may be called out with a reference numeral.

### DETAILED DESCRIPTION OF THE PREFERRED EMBODIMENTS

Reference is thus first made to FIG. 1, which illustrates an environment in which a collision avoidance system in accordance with preferred embodiments of the present invention may operate.

In accordance with a first embodiment, a collision avoidance environment in which at least one off-road vehicle preferably operates comprises at least one vehicle or object (moving or stationary) of a first type comprising a transmitting unit that transmits a signal that indicates at least the type of the at least one vehicle or object to which the transmitting unit is associated; wherein the at least first off-road vehicle is of a second type and comprises a vehicle and/or object detection and display unit (VODDU) that comprises a receiving unit for receiving the signal(s) transmitted by the transmitting unit associated with the at least first vehicle or object, a processor for processing the signals received by the receiving unit, and a display, associated with the at least first of-road vehicle, for displaying a first color pattern or sequence on the display that indicates at least the type of the at least one vehicle or object; wherein the display of the first color pattern or sequence indicates the type of the at least one vehicle or object detected in the environment by the receiving unit of the off-road vehicle.

In a first contemplated environment, the vehicle of the first type is not an off-road vehicle of the second type. For example, the vehicle of the first type may be and preferably is a surfacing vehicle, a snow groomer or an emergency vehicle, such as but not limited to, an ambulatory, fire or police vehicle, while the off-road vehicle (i.e. of the second type) is preferably one of a snowmobile, quad or other ATV.

In a more complex environment, the present invention contemplates that the environment may comprise at least a second vehicle of the second type comprising a transmitting unit that transmits a signal that at least indicates the type of the at least second vehicle to which the transmitting unit is associated; and wherein the receiving unit of the at least first off-road vehicle is configured for receiving the signal transmitted by the transmitting unit associated with the at least second vehicle; and wherein the display displays a second color pattern or sequence on the display that indicates the type of the at least second vehicle; wherein the display of the second color pattern or sequence indicates the type of the at least second vehicle. In this way, a rider associated with the at least first off-road vehicle can distinguish between the detection of a vehicle or object of the first type and the detection of a vehicle of the second type based on the color pattern or sequence being displayed on the display.

Advantageously, in the contemplated embodiment wherein the vehicle or object of the first type is not an off-road vehicle of the second type, the rider associated with the at least first off-road vehicle can distinguish between the detection of (i) a vehicle of a similar type to which the rider is associated and (ii) a vehicle or object of a type different from which the rider is associated. For example, a vehicle of the first type may be and preferably is a surfacing vehicle, a snow groomer or an emergency vehicle, and the off-road vehicle of the second type is preferably one of a snowmobile, quad or other ATV.

Thus, as illustrated in FIG. 1, the at least one moving vehicle or object of the first type may be a surfacing vehicle 200, a snow groomer 210 or an emergency vehicle 220, while the off-road vehicle of the second type may be a snowmobile 230, a quad 240 and/or other ATV 250. In addition, the vehicle of the second type is preferably the same type of vehicle as the first off road vehicle, e.g. snowmobile 230 (or it may be a quad or ATV, as the case may be). Thus, in preferred embodiments, it is contemplated that if the snowmobile 230 is the off-road vehicle of the second type, then (i) any of the foregoing other vehicles, e.g. surfacing vehicle 200, snow groomer 210, emergency vehicle 220, quad 240 and/or other ATV 250 could be the vehicle or object of the first type or (ii) any of the foregoing other vehicles, e.g. surfacing vehicle 200, snow groomer 210, or emergency vehicle 220 could be the vehicle or object of the first type or while the quad 240 or other ATV 250 could be considered to be an off-road vehicle of the second type.

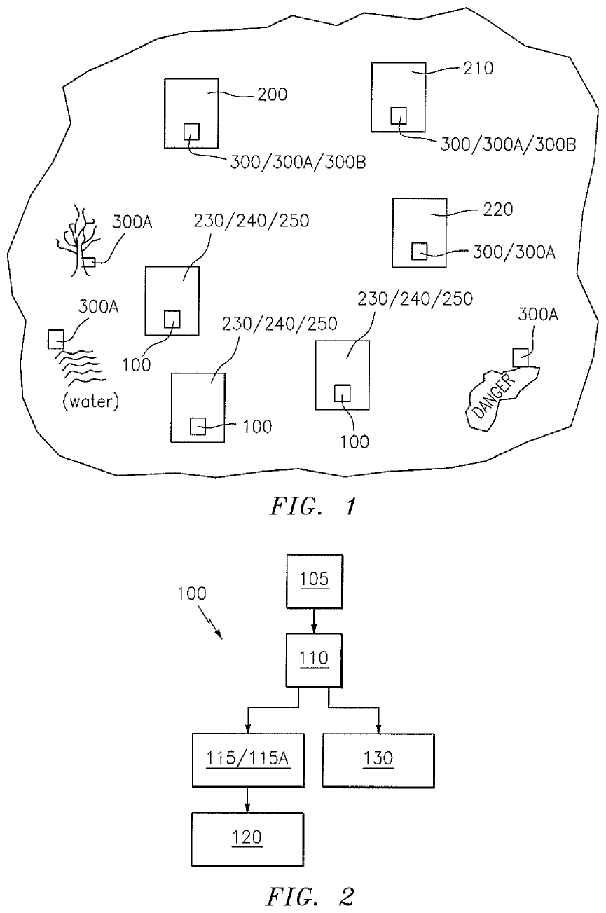

Reference is now made to FIG. 2, which illustrates a block diagram of a vehicle and/or object detection and display unit (VODDU), generally indicated at 100, constructed in accordance with preferred embodiments of the present invention. VODDU 100 preferably comprises at least a power supply 105, a processor 110, a receiving unit 115, an antenna 120 and a display unit, generally indicated at 130. These components are operatively coupled as illustrated in FIG. 2. Display unit 130 comprises, among other things, a plurality of lights in the form of LEDs, bulbs and/or any other known lighting elements, to carry out and provide display of the color pattern(s) or sequence(s) displayed on the display.

In a more complex but also preferred embodiment, the VODDU 100 associated with each of the off-road vehicles of the second type comprises a transceiver unit 115A instead of merely a receiving unit 115, so that each of the off-road vehicles of the second type can also themselves transmit signals that indicate the type of off-road vehicle (e.g. snowmobile, quad and/or other ATV) to which the transmitting unit of the respective transceiver 115A is associated. In this way, each and/or preferably all of the off-road vehicles in the environment can both transmit their own respective type of off-road vehicle and also receive the transmitted signals from each/all of the other off-road vehicles. In this way, each/all of the off-road vehicles of the second type can and will be able to identify the type of other vehicles or objects detected in the environment.

Preferably, VODDU 100 comprises a PCB with RF transmission and reception capability, an RF transmission and detection range of approximately one (1) kilometer (i.e. the environment radius as discussed herein) and is preferably provided with the capability to rotate 360° thereby providing for improved detection ability. The receiving unit and transmitting unit (i.e. transceiver 115A) may be installed on the surface of the vehicles and/or objects that are contemplated to be within the environment, and conveniently positioned for easy vision for the drivers of the off-road vehicles contemplated herein.

Preferably, the signals transmitted by any one of the transmitting units of any of the at least first vehicles or objects of the first type or vehicles of the second type are RF signals and may be frequency modulated and include information about the vehicles or objects of the first or second types. Preferably, the RF signals follow a data frame structure that may comprise one or more of the following, namely, a synchronization code, a serial number code, a data sequence, and a parity code. For example, the synchronization code may be used to inform a receiving unit of the arrival of the data to follow. The serial number code may be used to identify the transmitting unit to which it is associated and/or the type of vehicle or object to which it is associated. The data sequence may be used to transmits information about the status of the transmitting unit (i.e. and by extension, the vehicle and/or object to which it is associated), about its transmitting/receiving operation status and/or the type of vehicle or object to which it is associated. Finally, the parity code may be provided to complete the RF transmitted burst, which may be used to verify the integrity of the received signal.

It should also be understood that each of the vehicles or objects of the first type may also be provided with a receiving unit 300B (e.g. or transceiver 300 in lieu of only a transmitting unit 300A) so as to likewise be able to detect the existence and/or type of off-road vehicles of the second type, thereby providing additional safety to the operators of the vehicles of the first type.

Importantly, receiving unit 115/115A receives the signals transmitted by the transmitting unit associated with the first vehicle or object (200, 210, 220), processor 110 processes the signals received by the receiving unit 115/115A, and display 130, associated with the at least first of-road vehicle, displays color patterns or sequences on the display that provides significant and important information to the rider, such as for example and not limitation, the type of the vehicle or object detected; wherein the display of the color patterns or sequences preferably indicates, among other things, the type of the vehicles or objects detected in the environment by the receiving unit of the off-road vehicle. It should be understood that such transmitting units may be provided and associated with obstacles, dangerous or otherwise, danger points, on the trail(s) or within the environment, e.g. so as to alert the rider on the off road vehicle of the obstacles or other dangers detected within range and the type of such obstacles (e.g. lake, water hazard, etc).

In order for the off-road vehicle to be able to detect and identify the type of other vehicles and/or moving and/or stationary objects, the other vehicles (moving or otherwise) and/or moving and/or stationary objects that are to be detected and identified by type (e.g. a tree, lake, or other dangerous hazard) will also be equipped or associated with a unit that at least comprises a transmitting unit that can transmit a signal indicative of the type of vehicle, object and/or danger point or hazard.

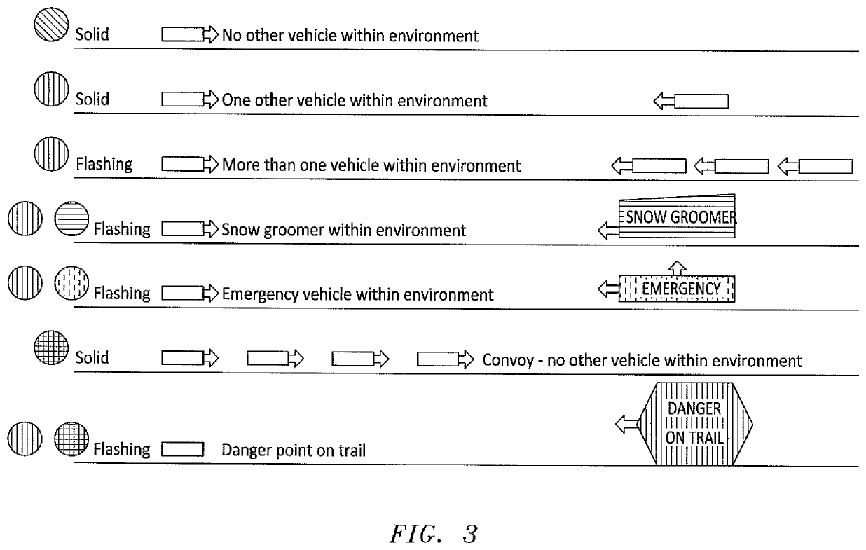

Reference is thus now made to FIG. 3, which illustrates exemplary color patterns or sequences in accordance with the present invention. For example, and not limitation, the following color pattern(s) and/or sequence(s) may be employed to indicate the following:
solid green Monitor active, indicating there are no other vehicles within the environment
solid red indicating that there is one other vehicle detected with in the environment
flashing red—indicating that there is more than one vehicle detected within the environment
flashing red & blue indicating the detection of a snow groomer or surfacing vehicle within the environment
flashing red & mauve indicating the detection of an emergency vehicle within the environment
solid yellow indicating that the rider is in a convoy with no other vehicle present within the environment (i.e. if the rider leaves the convoy for longer than 15 minutes and then returns, the rider will be identified as a new vehicle in the convoy)
flashing red & yellow indicating the detection of a danger point or dangerous object on the trail and/or within the environment

It should be understood that “color pattern(s) or sequence” shall mean any of the above colors, patterns (whether in shape, order, size, etc) or color sequence (i.e. order of colors, blinking of one or more colors and/or rate of blinking, etc.). It should also be understood that each, any and/or all of the foregoing may be displayed simultaneously or individually, such that the rider can be individually and/or simultaneously alerted to multiple types of vehicles and/or objects. In other words, it is contemplated that the display can, for example and not limitation, simultaneously alert the rider of the off-road vehicle to the detection of a snowgroomer, one or more other snowmobiles, a dangerous tree and other designated hazards, among other indications and alerts as exemplified herein.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense. Furthermore, to the extent that any of the features, function or structure described in U.S. Pat. No. 7,265,665 can be implemented and/or utilized in the present invention, such features, function and structure described in U.S. Pat. No. 7,265,665 is incorporated by reference as if fully set forth herein.

It should also be understood that the following claims are intended to cover all of the generic and specific features of the invention described herein and all statements of the scope of the invention that as a matter of language might fall therebetween.

What is claimed is:

1. A collision avoidance system for at least one off-road vehicle operating in an environment, wherein the environment comprises at least one vehicle or object of a first type comprising a transmitting unit that transmits a signal that indicates the type of the at least one vehicle or object to which the transmitting unit is associated, and wherein the at least a first off-road vehicle is of a second type, and comprises the collision avoidance system that itself comprises:
a receiving unit for receiving the signal transmitted by the transmitting unit associated with the at least one vehicle or object;
a processor for processing signals received by the receiving unit; and
a display for displaying a first color pattern or sequence that indicates the type of the at least one vehicle or object;
wherein the display of the first color pattern or sequence indicates the type of the at least one vehicle or object detected in the environment by the receiving unit of the off-road vehicle.

2. The collision avoidance system as claimed in claim 1, wherein the vehicle or object of the first type is not an off-road vehicle of the second type.

3. The collision avoidance system as claimed in claim 1, wherein the environment further comprises at least a second vehicle or object not of the second type comprising a transmitting unit that transmits a signal that indicates the type of the at least second vehicle or object to which the transmitting unit is associated, wherein the receiving unit of the collision avoidance system is configured for receiving the signal transmitted by the transmitting unit associated with the at least second vehicle or object; and the display displays a second color pattern or sequence that indicates the type of the at least second vehicle or object; and wherein the display of the second color pattern or sequence indicates the type of the at least second vehicle or object; and wherein:
the vehicle of the first type is one of a surfacing vehicle or snow groomer;
the vehicle or object not of the second type is an emergency vehicle or a tree or a designated danger hazard; and
the off-road vehicle of the second type is one of a snowmobile, quad or an ATV;
whereby a rider associated with the at least first off-road vehicle can identify the type of vehicle or object of the first type, the type of vehicle of the second type, and the type of the vehicle or object not of the second type based on the color pattern or sequence being displayed on the display.

4. The collision avoidance system as claimed in claim 3, wherein:
the display can simultaneously display the type of detected vehicle or object of the first type and the vehicle or object not of the second type.

5. The collision avoidance system as claimed in claim 3, wherein the environment further comprises a vehicle or object not of the first type or the second type comprising a transmitting unit that transmits a signal that indicates the type of the at least second vehicle or object not of the first or second type to which the transmitting unit is associated, wherein the receiving unit of the collision avoidance system is configured for receiving the signal transmitted by the transmitting unit associated with the vehicle or object not of the first or second type; and the display displays a third color pattern or sequence that indicates the type of the vehicle or object not of the first or second type; and wherein the display of the color pattern or sequence indicates the type of the vehicle or object not of the first or second type; and wherein:
the vehicle of the first type is one of a surfacing vehicle or snow groomer;
the vehicle or object not of the first type or second type is an emergency vehicle or a tree or a designated danger hazard; and
the off-road vehicle of the second type is one of a snowmobile, quad or an ATV;
whereby a rider associated with the at least first off-road vehicle can identify the type of vehicle or object of the first type, the type of vehicle of the second type, and the type of the vehicle or object not of the first or second type based on the color pattern or sequence being displayed on the display.

6. The collision avoidance system as claimed in claim 1, wherein the environment comprises at least a second vehicle of the second type comprising a transmitting unit that transmits a signal that indicates the type of the at least second vehicle to which the transmitting unit is associated, and
wherein:
the receiving unit of the collision avoidance system is configured for receiving the signal transmitted by the transmitting unit associated with the at least second vehicle of the second type;
the display displays a second color pattern or sequence that indicates the type of the at least second vehicle; and
the display of the second color pattern or sequence indicates the type of the at least second vehicle of the second type;
whereby a rider associated with the at least first off-road vehicle can distinguish between the type of vehicle or object of the first type and the detection of a vehicle of the second type based on the color pattern or sequence being displayed on the display.

7. The collision avoidance system as claimed in claim 6, wherein:
the vehicle or object of the first type is not an off-road vehicle of the second type;
whereby the rider associated with the at least first off-road vehicle can distinguish between the detection of (i) a vehicle of a similar type to which the rider is associated and (ii) a vehicle of a type different from which the rider is associated.

8. The collision avoidance system as claimed in claim 6, wherein:
the vehicle of the first type is one of a surfacing vehicle, snow groomer or an emergency vehicle;
and the off-road vehicle of the second type is one of a snowmobile, quad or an ATV.

9. An environment comprising at least one vehicle or object of a first type comprising a transmitting unit that transmits a signal that indicates the type of the at least one vehicle or object to which the transmitting unit is associated, and at least a first off-road vehicle of a second type comprising the collision avoidance system as claimed in claim 1, wherein the display of the first color pattern or sequence indicates the type of the at least one vehicle or object detected in the environment by the receiving unit of the off-road vehicle.

10. An environment comprising at least one vehicle or object of a first type comprising a transmitting unit that transmits a signal that indicates the type of the at least one vehicle or object to which the transmitting unit is associated, at least a second vehicle of a second type comprising a transmitting unit that transmits a signal that indicates the type of the at least second vehicle to which the transmitting unit is associated, and at least a first off-road vehicle of a second type comprising the collision avoidance system as claimed in claim 6, wherein the display of the color pattern or sequence indicates the type of the at least one vehicle or object and/or second vehicle detected in the environment by the receiving unit of the off-road vehicle.

11. A method of distinguishing at least a first vehicle or object of a first type from at least a vehicle of a second type in a collision avoidance system for at least one off-road vehicle operating in an environment, wherein the at least one vehicle or object of the first type comprises a transmitting unit that transmits a signal that indicates the type of the at least one vehicle or object, the at least second vehicle of the second type comprises a transmitting unit that transmits a signal that indicates the type of the at least second vehicle, the at least first off-road vehicle is of the second type and comprises (i) a receiving unit for receiving signals transmitted by the transmitting units associated with the at least first vehicle or object and the at least second vehicle, (ii) a processor for processing signals received by the receiving unit, and (iii) a display that displays a first color pattern or sequence indicative of the type of the at least one vehicle or object and displays a second color pattern or sequence indicative of the type of the at least second vehicle, wherein the method comprises the steps of:
detecting, by the receiving unit associated with the off-road vehicle, the signals being transmitted by the respective transmitting units associated with the at least first vehicle or object of the first type and the at least second vehicle of the second type; and
displaying on the display the first color pattern or sequence to indicate the detection of the signal from the at least first vehicle or object of the first type and/or the second color pattern or sequence to indicate the detection of the signal from the at least second vehicle of the second type;
wherein a rider associated with the at least first off-road vehicle can distinguish between the detection of a vehicle or object of the first type and the detection of a vehicle of the second type based on the one or more colors patterns or sequences being displayed on the display.

12. A collision avoidance system for at least one off-road vehicle operating in an environment, wherein the environment comprises (i) a vehicle or object of a first type comprising a transmitting unit that transmits a signal that provides identifying information about the at least one vehicle or object to which the transmitting unit is associated and/or (ii) a vehicle of a second type comprising a transmitting unit that transmits a signal that provides identifying information about the at least second vehicle to which the transmitting unit is associated; and wherein the at least first off-road vehicle is of a second type, and comprises the collision avoidance system that itself comprises:
a receiving unit for receiving the signals transmitted by the transmitting units associated with the at least first vehicle or object and the at least second vehicle;
a processor for processing signals received by the receiving unit; and
a display for displaying, simultaneously and/or individually, different color patterns or sequences that indicates one or more of the following:
(i) an indication that the receiving unit is not receiving a signal from the at least first vehicle or object or the second vehicle; an indication that the receiving unit is receiving a signal from the first vehicle or object and/or the second vehicle;
(ii) an indication that the receiving unit is receiving a signal from a vehicle or object of the first type;
(iii) an indication that the receiving unit is receiving a signal from a vehicle of the second type;
(iv) an indication that the receiving unit is receiving a signal from more than one vehicle or object of the first type;
(v) an indication that the receiving unit is receiving a signal from more than one vehicle of the second type;
(vi) an indication that the signal being received from the vehicle or object of the first type is a snow groomer or surfacing vehicle or emergency vehicle;
(vii) an indication that the off road vehicle is in a convoy with no other vehicles of the second type; and/or
(viii) an indication that the off-road vehicle is approaching an object of the first type and the type of the object of the first type.

13. The collision avoidance system as claimed in claim 12, wherein the object is a tree, water hazard and/or other designated danger zone.

14. The collision avoidance system as claimed in claim 12, wherein the transmitting unit of the at least one vehicle or object of the first type and/or the transmitting unit of the vehicle of the second type transmits a signal that indicates the type of the at least one vehicle or object of the first type or the vehicle of the second type to which the transmitting unit is associated.

15. The collision avoidance system as claimed in claim 1, wherein the signals are RF signals.

16. The collision avoidance system as claimed in claim 12, wherein the signals are RF signals.
